(19) United States
(12) Patent Application Publication
(10) Pub. No.: US 2017/0182904 A1
(43) Pub. Date: Jun. 29, 2017

(54) DEVICE AND METHOD FOR DETERMINING A SETPOINT CORRECTED FOR THE NEUTRAL CURRENT OF AN ELECTRICAL OR HYBRID AUTOMOTIVE VEHICLE BATTERY CHARGER WITHOUT GALVANIC ISOLATION

(71) Applicant: RENAULT s.a.s., Boulogne Billancourt (FR)

(72) Inventors: Pedro KVIESKA, Versailles (FR); Ludovic MERIENNE, Gif Sur Yvette (FR)

(73) Assignee: RENAULT s.a.s., Boulogne Billancourt (FR)

(21) Appl. No.: 15/327,468

(22) PCT Filed: Sep. 8, 2015
(86) PCT No.: PCT/FR2015/052373

§ 371 Date: Jan. 19, 2017

(30) Foreign Application Priority Data
Sep. 22, 2014 (FR) 1458922

(51) Int. Cl. B60L 11/18; H02M 5/42; H02J 7/02

(52) U.S. Cl. CPC B60L 11/1844; H02J 7/022; H02M 5/42; Y10S 903/907

(57) ABSTRACT

A device determines a corrected setting of a neutral current at an output of a rectifier stage of an electrical or hybrid automotive vehicle battery charger without galvanic isolation. The device includes a phase-locked loop to determine an instantaneous frequency of the network as a function of a measurement of a voltage of an electrical supply network, a regulating mapping to determine a neutral current setting as a function of a setting of battery current, a device to calculate an amplitude of a frequency variation of the network as a function of the instantaneous frequency, a correction mapping that receives as input a value of the amplitude of the frequency variation and emits as output a correction value of the neutral current setting, and a summer to determine a corrected neutral current setting by adding the correction value of the neutral current setting to the neutral current setting.

The technical domain of the invention is that of in-vehicle automotive vehicle battery chargers and more particularly the use of such chargers on disturbed electrical supply networks.

In-vehicle chargers without galvanic isolation are sensitive to disturbed electrical supply networks, particularly as far as low frequency voltage harmonics are concerned. In some cases, connection to a disturbed network causes a load disconnection, which is not desirable for the users. It is also possible to see the appearance of over-currents, which can severely test the power electronics. Said over-currents also cause faults that induce load disconnections.

One solution for preventing this is to adopt a wider margin in respect of the currents circulating in the charger. However, this has the disadvantage of degrading charger output. Furthermore, a reduction of charger output in all cases of use in order to ensure full availability of the load independently of network quality also seems to be inadmissible to the users.

A technical problem therefore exists of reconciling a high load output with availability of the load irrespective of the quality of the electrical supply network.

The following documents are known from the prior art.

Document WO2012052190 discloses a decomposition and mitigation of a disturbance being present at an electrical connection between an electrical power generating system and a power grid. This document describes a system allowing the quality of a power grid to be improved by injecting suitably adapted current. It is a complete system that cannot be adapted for a motor vehicle.

Document EP1665495 discloses a method for operating a wind turbine during a disturbance in the grid. This document indicates that the power supplied by a wind turbine system varies as a function of the appearance of a fault in the grid.

These documents are quite far from the automotive vehicle domain and therefore provide no information on reconciling, in this domain, a high load output with availability of the load.

The object of the invention is a device for determining a corrected setting of the neutral current of an electrical or hybrid automotive vehicle battery charger without galvanic isolation, the charger being supplied by an electrical supply network.

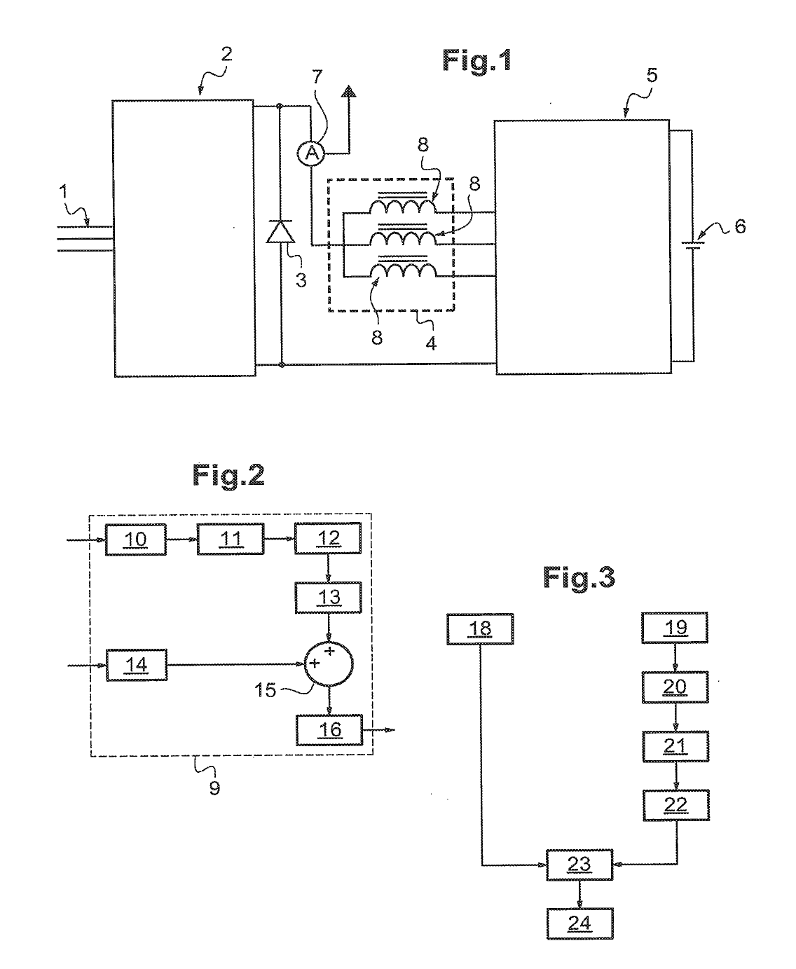

FIG. 1 shows the main units of an in-vehicle charger without galvanic isolation. A three-phase network 1 is connected to a voltage step-down rectifier with reference number 2. The cathode of a diode 3 is connected to the first output of the voltage step-down rectifier 2, its anode being connected to the second output of the voltage step-down rectifier 2. A first output of the voltage step-down rectifier 2 is connected to the inductances 8 of an electrical machine 3, said inductances being connected in turn to a voltage step-up inverter with reference number 5. The outputs of the voltage step-up inverter 5 are connected to the battery 6.

The neutral current is measured by a current-measuring sensor 7 between the first output of the voltage step-down rectifier 2, the cathode of the diode 3 and the electrical machine 4. Document FR2943188 illustrates in more detail the structure of a charger such that described above.

More generally, “neutral current” in this patent application is the direct current from the bus at the output of the input rectifier of a charger without galvanic isolation including said input rectifier, generally followed by a voltage step-up stage. This term “neutral current” arises from the fact that, in the case of document FR2943188, this current arrives at the neutral input of the stator coils re-used in the voltage step-up stage of the charger as energy storage inductances. The invention also applies to other types of chargers including at least one rectifier stage. In the variant of document FR2943188 including an additional inductance in series between the ammeter 7 and the stator coils 8, the “neutral current” is the current passing through said additional inductance.

The device comprises a phase-locked loop able to determine an instantaneous frequency of the network as a function of a measurement of the voltage of the electrical supply network, and a regulating mapping able to determine a neutral current setting as a function of a setting of battery current.

The device furthermore comprises a means for calculating the amplitude of the frequency variation of the network as a function of the instantaneous frequency of the network, a correction mapping receiving as input the value of the amplitude of the frequency variation and emitting as output a correction of the neutral current setting, and a summer able to determine a corrected setting of neutral current by adding the correction value of the neutral current setting to the neutral current setting.

The device can comprise a low pass filter of the rise setting of the neutral current.

The device can comprise a saturation means able to limit the corrected neutral current setting output from the summer in order not to exceed a maximum value of the neutral setting.

Another object of the invention is a method for determining a corrected setting of the neutral current at the output of a rectifier stage of an electrical or hybrid automotive vehicle battery charger without galvanic isolation, the charger being supplied by an electrical supply network.

The method comprises the following steps:

an instantaneous frequency of the network is determined by loop phase locking as a function of a measurement of the voltage of the electrical supply network, and

a neutral current setting is determined as a function of a setting of battery current.

The method furthermore comprises the following steps:

the amplitude of the instantaneous frequency variation of the network is calculated,

a correction of the neutral current setting is determined as a function of the amplitude of the instantaneous frequency variation of the network, and

the correction of the neutral current setting is added to the neutral current setting.

The correction of the neutral current setting can be filtered through a pass band filter.

The corrected neutral current settling can be saturated in order not to exceed a maximum value of the neutral setting.

Other aims, characteristics and advantages of the invention will emerge on reading the following description, given only as a non-limitative example and made with reference to the attached drawings, on which:

FIG. 1 illustrates the main units of an in-vehicle charger without galvanic isolation,

FIG. 2 illustrates the main units of a device for determining a corrected setting of the neutral current, and

FIG. 3 illustrates the main steps of the method for determining a corrected setting of the neutral current.

The power regulation of in-vehicle chargers without galvanic isolation, whether three-phase or single-phase, depends on the quality of the electrical network. In a charger such as FIG. 1 describes, an additional inductance is possibly added between the ammeter 7 and the stator coils 8, but said inductance remains small in order to minimize the costs and the size of the charger. This implies that disturbances appearing on the network will be fed back to the neutral current of the charger, that is to say at the output of the voltage step-down rectifier 2, even if these disturbances are partially offset by the regulation included in the charger.

Such regulation uses a value of the electrical angle to determine the current position of the electrical cycle and to perform the three-phase Park transforms or calculate the desired single-phase current at the output of the voltage step-down rectifier. The value of the electrical angle is determined by a phase locked loop (PLL).

The network voltage can be written as:

V(t)=V₀*sin(ωt), (2)

where V₀ is amplitude, ω is pulsation and t is time.

The output of the phases-locked loop then corresponds to the term ωt.

For various reasons described in document FR2974253, the neutral current setting must be higher at all times than the input currents and the battery current. When disturbances exist on the electrical supply network, the neutral current is disturbed, and this can propagate into the line current. The line current is the current in the phases, and hence the current at the charger input. At this current is constructed from the neutral current, disturbances of the neutral current therefore exist in the charger input current. In practice, the result is that it is impossible to draw the desired current from the electrical supply network. In some cases, the effect of disturbances is that regulating cannot hold the current at its setting, which can lead to a load disconnection. In other cases, regulating can be disturbed to the extent where the battery current reaches dangerous levels for the system.

In fact, in normal operation of the system, the neutral current rises, then oscillates around the current setting during a pre-charging phase. It is then regulated around this setting value, with slight oscillations.

However, with a charger of the prior art, injecting a 9% disturbance on the third order harmonic of the three-phase network, namely, for example, 150 Hz, causes a load disconnection.

This disconnection is the result of over-current protection (OCP), set to approximately 300 A and present in the charger. This protection is independent of the regulation.

One solution to this problem, as mentioned above, would be to raise the value of the neutral current setting. More precisely, load disconnections due to zero neutral current or OCP happen when the line current can no longer be correctly constructed. This happens when the neutral current is too low. It is then said to “touch” the line current. The more the network is disturbed, the more the neutral current will be disturbed, and the greater the possibility that the desired line current is level with the neutral current. By increasing the neutral current setting in spite of oscillations increased by disturbances, regulating works better. In the above example of injecting a 9% disturbance on the third order harmonic of the three-phase network, a 30 A higher neutral current setting enables the regulating function to be maintained without danger, in spite of significant oscillations. This solution therefore allows the vehicle battery to continue charging.

However, changing the neutral current setting must be performed as a function of the control electronics. In fact, the neutral current setting cannot rise indefinitely and must always respect the maximum neutral current value that would trigger the OCP. It is therefore possible to think that this solution will not always be applicable to the maximum charging power. In fact, in such a case, the neutral current is already very high and distant from the maximum value by a small margin.

Thus, if it is possible to identify that the network is disturbed, the load availability on disturbed networks is improved if the neutral current setting is raised. The counterpart to this improvement is a poorer output on these disturbed networks, and hence a longer charging time than on a network exempt of disturbances.

The quality of the network can be estimated simply and reliably through the output of the phase-locked loop. As described above, the phase-locked loop allows the voltage sine to be reconstructed by making the assumption of equation 1.

The phase-locked loop also has the instantaneous frequency f=ω/2π as output.

If the phase-locked loop functions perfectly, ωt is a saw-tooth signal oscillating between 0 and 2π, and the frequency is constant. The more the network becomes disturbed (in particular at low frequency), the more the signal ωt is distorted, which corresponds to an instantaneous frequency that is not constant.

In the case of a correctly functioning phase-locked loop, the frequency is constant and the amplitude of the frequency variation is a few percent over the some hundreds of milliseconds. In other words, when there is little disturbance on the network, the frequency emitted at the output of the phase-locked loop varies little.

It is possible to simulate a disturbed supply network by inserting, for example, a 7% disturbance of the fifth order harmonic of the network. In such a case, the phase-locked loop is also disturbed before and after charging with frequency variations larger by at least one order.

It is therefore possible to conclude that the output amplitude of the instantaneous frequency of the phase-locked loop is a reliable indicator for estimating the quality of the electrical supply network.

Furthermore, when simulating a disturbed network, it emerges that raising the current setting, for example by 30 A, allows the battery charge to be maintained in spite of significant variations of the network frequency.

Loop phase locking is therefore a reliable indicator of network disturbance.

The neutral current setting is currently determined by means of a mapping, which depends on the battery current setting. In turn, the battery current setting is an image of the power.

Thus, in order to maintain the ability to charge the battery when the electrical supply network is disturbed, a correction (11, 12, 13, 15) is added of the neutral current setting originating from this mapping, known here as regulating mapping 14. The correction depends on the amplitude of the frequency variation of the electrical supply network originating in the phase-locked loop 10. The determination of the amplitude of the correction as a function of the frequency variations at the output of the phase-locked loop depends on each type of vehicle charger, so that an empirical determination must be made.

FIG. 2 illustrates the device 9 for determining a corrected setting of the neutral current, which comprises a phase-locked loop 10, a means 11 for calculating the amplitude of frequency variation, a correction mapping 12, a low pass filter 13, a regulating mapping 14, a summer 15 and a saturation means 16.

The phase-locked loop 10 receives as input a measurement of the voltage of the electrical supply network and emits as output an instantaneous frequency of this network.

The means 11 for calculating the amplitude of the frequency variation of the network receives this instantaneous frequency and emits a value of the amplitude of the frequency variation, in particular in Hz.

The correction mapping 12 receives as input the value of the amplitude of the frequency variation and emits as output a correction of the neutral current setting, in particular in the form of a raised setting of the neutral current. For example, a value of the amplitude of the frequency variation of 5 Hz can correspond to a rise of 30 A of the neutral current setting.

The correction value of the neutral current setting is filtered by the low pass filter 13, which is used to prevent sudden changes of setting.

The regulating mapping 14 allows the neutral current setting to be determined as a function of a setting of battery current.

The summer 15 allows the correction value for the neutral current setting originating from the low pass filter 13 to be added to the neutral current setting at the output of the regulating mapping 14.

The saturation means 16 allow the corrected neutral current setting to be limited at the output of the summer 15 in order not to exceed the physical limits of the system. In fact, the maximum value of the neutral setting is not infinite because of the presence of the OCP.

FIG. 3 illustrates the method for determining a corrected setting of the neutral current.

During a first step 18, a neutral current setting is determined as a function of a setting of battery current.

During a second step 19, an instantaneous frequency of the electrical supply network is determined by means of a phase-locked loop applied to a measurement of the voltage of the electrical supply network.

During a third step 20, the amplitude of the instantaneous frequency variation of the network is calculated, then a correction of the neutral current setting is determined as a function of the amplitude of the instantaneous frequency variation of the network, during a fourth step 21.

During a fifth step 22, the correction of the neutral current setting is filtered, then the neutral current setting is added to it during a sixth step 23.

During a seventh step 24, the corrected neutral current setting is then saturated as a function of parameters of the system, in particular with regard to the over-current protection OCP.

1. A device for determining a corrected setting of a neutral current at an output of a rectifier stage of an electrical or hybrid automotive vehicle battery charger without galvanic isolation, the charger being able to be supplied by an electrical supply network, the device comprising:
phase-locked loop to determine an instantaneous frequency of the network as a function of a measurement of a voltage of the electrical supply network;
a regulating mapping to determine a neutral current setting as a function of a setting of battery current;
means for calculating an amplitude of a frequency variation of the network as a function of the instantaneous frequency of the network;
a correction mapping that receives as input a value of the amplitude of the frequency variation and emits as output a correction value of the neutral current setting; and
a summer to determine a corrected neutral current setting by adding the correction value of the neutral current setting to the neutral current setting.

2. The device as claimed in claim 1, further comprising a low pass filter of the correction value of the neutral current setting.

3. The device as claimed in claim 1, further comprising a saturation means to limit the corrected neutral current setting output from the summer in order not to exceed a maximum value of the neutral current setting.

4. A method for determining a corrected setting of a neutral current at an output of a rectifier stage of an electrical or hybrid automotive vehicle battery charger without galvanic isolation, the charger being supplied by an electrical supply network, the method comprising:
determining an instantaneous frequency of the network by loop phase locking as a function of a measurement of a voltage of the electrical supply network;
determining a neutral current setting as a function of a setting of battery current;
calculating an amplitude of an instantaneous frequency variation of the network;
determining a correction of the neutral current setting as a function of the amplitude of the instantaneous frequency variation of the network; and
adding the correction of the neutral current setting to the neutral current setting.

5. The method as claimed, in claim 4, further comprising filtering the correction of the neutral current setting through a low pass filter.

6. The method as claimed in claim 4, further comprising saturating the corrected neutral current setting in order not to exceed a maximum value of the neutral setting.
